(19) United States
(12) Patent Application Publication
(10) Pub. No.: US 2002/0184172 A1
(43) Pub. Date: Dec. 5, 2002

(54) Object class definition for automatic defect classification

(76) Inventors: Vladimir Shlain, Haifa (IL); Andrew Gleibman, Yokneam-Illit (IL)

Correspondence Address: DANIEL J SWIRSKY, PO BOX 2345, BEIT SHEMESH, 99544, IL

(21) Appl. No.: 10/122,423

(22) Filed: Apr. 16, 2002

Related U.S. Application Data
(60) Provisional application No. 60/283,633, filed on Apr. 16, 2001.

(51) Int. Cl. G06F 15/18

(52) U.S. Cl. 706/20; 706/62

(57) ABSTRACT

A method for object class definition for a plurality of objects, the method including evaluating each of a plurality of features for each of the objects, thereby resulting in a feature value for each object-feature combination, performing cluster analysis on the objects to identify clusters of the objects having common features, calculating an average feature value for each feature in each of the clusters, and expressing a predefined statement associated with any of the cluster features in any of a positive, negative, and intermediate form corresponding to the cluster feature's average feature value.

### CROSS-REFERENCE TO RELATED APPLICATIONS

This application claims the benefit of U.S. Provisional Patent Application Ser. No. 60/283,633, filed Apr. 16, 2001, entitled “Device and Method for Semiautomatic Clustering Plurality of Objects,” and incorporated herein by reference in its entirety.

### FIELD OF THE INVENTION

The present invention relates to automatic classification of objects in general, and more particularly to object class definition in learning sets.

### BACKGROUND OF THE INVENTION

Automatic object classification is an increasingly important aspect of many industrial systems. For instance, automatic defect classification (ADC) is important aspect of semiconductor production. In conventional classification systems, classification rules are derived from a learning set (also referred to as a training set) of reference objects, such as defect images in ADC, and then applied in a production environment. During object class definition, objects, such as defect images, are “binned” into logical groups which are then tagged with class names according to their common properties. In order to create the learning set, object class definition is applied to a representative set of objects. Object class definition is a crucial part of ADC, as a poorly formed learning set will yield poorly formed classification rules and, consequently, poor subsequent object classification.

Currently, object class definition is done manually. Given a set of object features, the ADC system user locates and names object features, and then defines specific object classes. A method for automating object class definition during the construction of the learning set would therefore be advantageous.

### SUMMARY OF THE INVENTION

The present invention provides ontological and clustering techniques for automating the definition of classes of unclassified objects, such as when constructing ADC learning sets using unclassified defect images. The present invention provides semiautomatic means for preparation of a learning set which may then be used for generation of object classification rules. Defining new object classes is easily facilitated, while subjectivity in definition of new object classes is reduced.

The present invention assists the user in binning objects into groups and choosing appropriate object class names. A hierarchical knowledge base, methods of natural language text generation, and methods of cluster analysis are employed to automatically provide an expressive description of the obtained clusters.

In one aspect of the present invention there is provided a method for object class definition for a plurality of objects, the method including evaluating each of a plurality of features for each of the objects, thereby resulting in a feature value for each object-feature combination, performing cluster analysis on the objects to identify clusters of the objects having common features, calculating an average feature value for each feature in each of the clusters, and expressing a predefined statement associated with any of the cluster features in any of a positive, negative, and intermediate form corresponding to the cluster feature's average feature value.

In another aspect of the present invention there is further included providing an ontology tree including a plurality of predetermined features.

In another aspect of the present invention there is further included selecting a plurality of the features from the ontology tree.

In another aspect of the present invention the selecting step includes selecting a plurality of bottom-level nodes of the ontology tree.

In another aspect of the present invention there is further included accepting a selection by a user of a plurality of the features from the ontology tree.

In another aspect of the present invention the accepting step includes accepting the selection of a plurality of bottom-level nodes of the ontology tree.

In another aspect of the present invention the providing step includes providing the ontology tree with a plurality of top-level feature groups, each of the top-level feature groups including at least one bottom-level node.

In another aspect of the present invention the providing step includes providing the plurality of top-level feature groups where each of the plurality of top-level feature groups defines an orthogonal category of the features.

In another aspect of the present invention the providing step includes providing a plurality of top-level feature groups, each of the top-level feature groups including at least one bottom-level node, each of the plurality of top-level feature groups defining an orthogonal category of the features, and the selecting step includes selecting no more than one bottom-level node from each orthogonal top-level feature group.

In another aspect of the present invention the providing step includes providing a plurality of top-level feature groups, each of the top-level feature groups including at least one bottom-level node, each of the plurality of top-level feature groups defining an orthogonal category of the features, and the accepting step includes accepting no more than one bottom-level node from each orthogonal top-level feature group.

In another aspect of the present invention there is further included associating any of the features with any of a property, a statement, and a predicate.

In another aspect of the present invention there is further included combining a plurality of the statements expressed for any of the clusters to form a sentence that describes the cluster.

In another aspect of the present invention the performing step includes constructing a matrix of the objects and the features, computing a triangular distance matrix of the Euclidean distances between the objects in the object-feature matrix, computing a histogram of the distance matrix using a predetermined number of histogram intervals, computing a distance threshold using the minimum of a first and a second peak of the histogram, computing a triangular incidence matrix using the distance matrix where a first value is recorded in the incidence matrix for any object member of the distance matrix that exceeds the distance threshold, a second value is recorded in the incidence matrix for any object member of the distance matrix that does not exceed the distance threshold, and constructing a cluster array using a matrix of incidences where a number of clusters is calculated where any of the objects belongs to the same cluster if the second value is recorded for the object member, and any of the objects belongs to the same cluster if the first value is recorded for the object member.

In another aspect of the present invention the performing step includes for each of a plurality of iterations calculating a fuzzy membership function related to each cluster for each of the objects using the distance between each cluster center and a current object, calculating a fuzzy center for each of the clusters and a clustering quality estimation value using the fuzzy membership function, and concluding the iterations when either of the distance between the centers of the clusters of two nonconcurrent iterations and the difference between the clustering quality estimation values is less then a predefined threshold.

In another aspect of the present invention there is provided a system for object class definition for a plurality of objects, the system including means for evaluating each of a plurality of features for each of the objects, thereby resulting in a feature value for each object-feature combination, means for performing cluster analysis on the objects to identify clusters of the objects having common features, means for calculating an average feature value for each feature in each of the clusters, and means for expressing a predefined statement associated with any of the cluster features in any of a positive, negative, and intermediate form corresponding to the cluster feature's average feature value.

In another aspect of the present invention the objects comprise a learning set.

In another aspect of the present invention there is further included an ontology tree including a plurality of predetermined features.

In another aspect of the present invention there is further included means for selecting a plurality of the features from the ontology tree.

In another aspect of the present invention the means for selecting is operative to select a plurality of bottom-level nodes of the ontology tree.

In another aspect of the present invention there is further included means for accepting a selection by a user of a plurality of the features from the ontology tree.

In another aspect of the present invention the means for accepting is operative to accept the selection of a plurality of bottom-level nodes of the ontology tree.

In another aspect of the present invention the ontology tree includes a plurality of top-level feature groups, each of the top-level feature groups including at least one bottom-level node.

In another aspect of the present invention each of the plurality of top-level feature groups defines an orthogonal category of the features.

In another aspect of the present invention any of the features is associated with any of a property, a statement, and a predicate.

In another aspect of the present invention the property expresses a concept of interest in a verbal form.

In another aspect of the present invention the statement expresses the property as a positive verbal statement.

In another aspect of the present invention the predicate is a system-level name of a formal feature which is related to a specific algorithm for calculating a feature value for any of the objects.

In another aspect of the present invention a plurality of the statements expressed for any of the clusters are combinable to form a sentence that describes the cluster.

In another aspect of the present invention there is further included means for constructing a matrix of the objects and the features, means for computing a triangular distance matrix of the Euclidean distances between the objects in the object-feature matrix, means for computing a histogram of the distance matrix using a predetermined number of histogram intervals, means for computing a distance threshold using the minimum of a first and a second peak of the histogram, means for computing a triangular incidence matrix using the distance matrix where a first value is recorded in the incidence matrix for any object member of the distance matrix that exceeds the distance threshold, a second value is recorded in the incidence matrix for any object member of the distance matrix that does not exceed the distance threshold, and means for constructing a cluster array using a matrix of incidences where a number of clusters is calculated where any of the objects belongs to the same cluster if the second value is recorded for the object member, and any of the objects belongs to the same cluster if the first value is recorded for the object member.

In another aspect of the present invention there is further included means for calculating a fuzzy membership function related to each cluster for each of the objects using the distance between each cluster center and a current object, means for calculating a fuzzy center for each of the clusters and a clustering quality estimation value using the fuzzy membership function, and means for determining, for at least two nonconcurrent applications the of the means for calculating a fuzzy center, when either of the distance between the centers of the clusters calculated and the difference between the clustering quality estimation values is less then a predefined threshold.

In another aspect of the present invention the objects are microchip defect images, and where the features describe microchip defect image attributes.

### BRIEF DESCRIPTION OF THE DRAWINGS

The present invention will be understood and appreciated more fully from the following detailed description taken in conjunction with the appended drawings in which:

FIG. 1 is a simplified flowchart illustration of a method of object class definition, operative in accordance with a preferred embodiment of the present invention;

FIG. 2 is a simplified flowchart illustration of a method of clustering objects, where the number of clusters is not known a priori, operative in accordance with a preferred embodiment of the present invention;

FIG. 3 is a simplified flowchart illustration of a method of clustering objects, where the number of clusters is known a priori, operative in accordance with a preferred embodiment of the present invention; and

FIG. 4 is a simplified conceptual illustration of an object class definition system, constructed and operative in accordance with a preferred embodiment of the present invention.

### DETAILED DESCRIPTION OF PREFERRED EMBODIMENTS

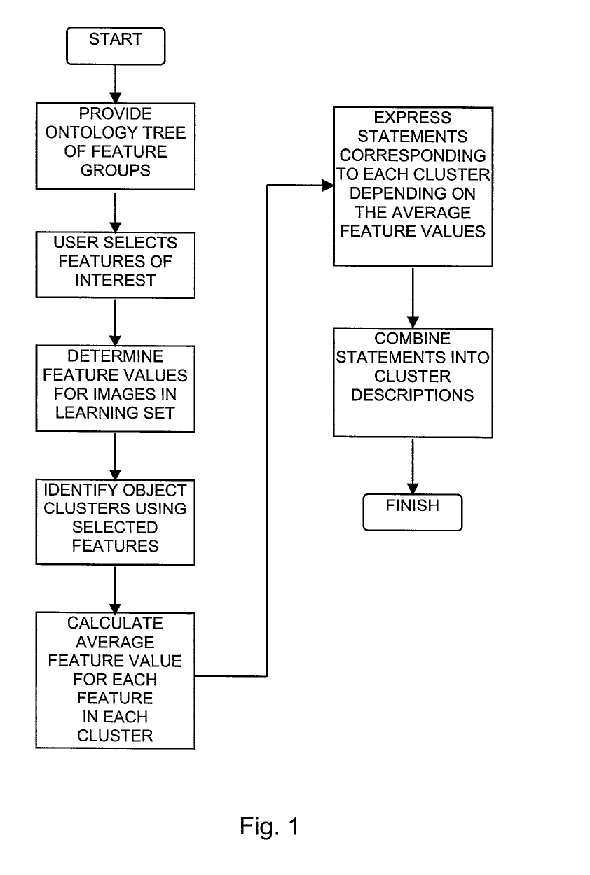

Reference is now made to FIG. 1, which is a simplified flowchart illustration of a method of object class definition, operative in accordance with a preferred embodiment of the present invention. In the method of FIG. 1 an ontology tree of predetermined features is provided to the ADC user. The ontology tree typically has multiple levels of feature groupings and sub-groupings. For example, the top level of the ontology tree may include the following categories of microchip defect features:

Pattern Texture—Information about the microchip layer pattern that is unaffected by the defect;

Defect Form—Form of the defected area;

Defect Color Properties—Information about the main defect color and other colored areas.

Bottom-level nodes of the ontology tree are preferably expressed as properties, statements, and predicates, where a property expresses a concept of interest in a verbal form, a statement expresses the property as a positive verbal statement, and a predicate is a system-level name of a formal feature which is related to a specific algorithm for calculating feature values for an object. An example of an abbreviated branch of an ontology tree is as follows:

{Defect Color Properties

. . .
{Color areas present

{Green Area

{property : Presence of a green area on the defect
statement: Defect has a green area
predicate: Has_Green_Area

}

. . .
}

. . .
}
. . .

In this example, the sequence “Defect Color Properties→Color areas present→Green Area” defines a navigation path to a bottom-level node in the ontology tree. The positive statement “Defect has a green area” may be modified into the negative form “Defect does not have a green area” and one or more intermediate forms, such as “Defect has a somewhat green area”, each related to a different degree of presence of green color in the defect area.

The correlation between features is preferably taken into account while constructing the ontology tree. Preferably, each top-level feature group defines an orthogonal category of features.

Continuing with the method of FIG. 1, user selection of features of interest is performed by navigating the ontology tree and selecting bottom-level nodes. Preferably, no more than one bottom-level node is selected from each orthogonal top-level feature group. Thus, where there are eight top-level feature groups, no more than eight bottom-level feature nodes are selected.

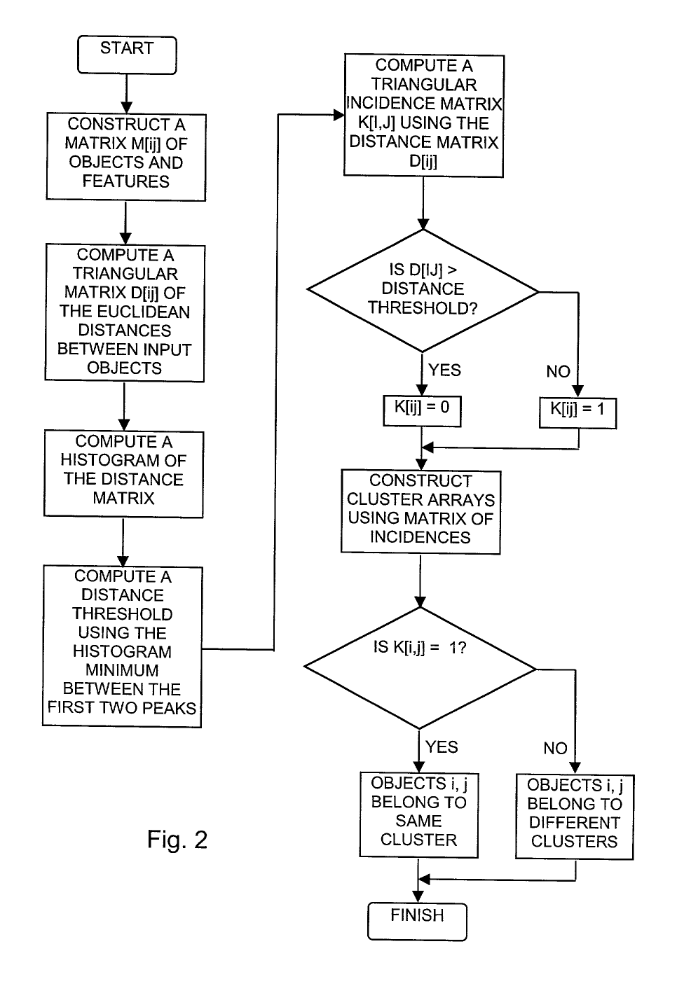

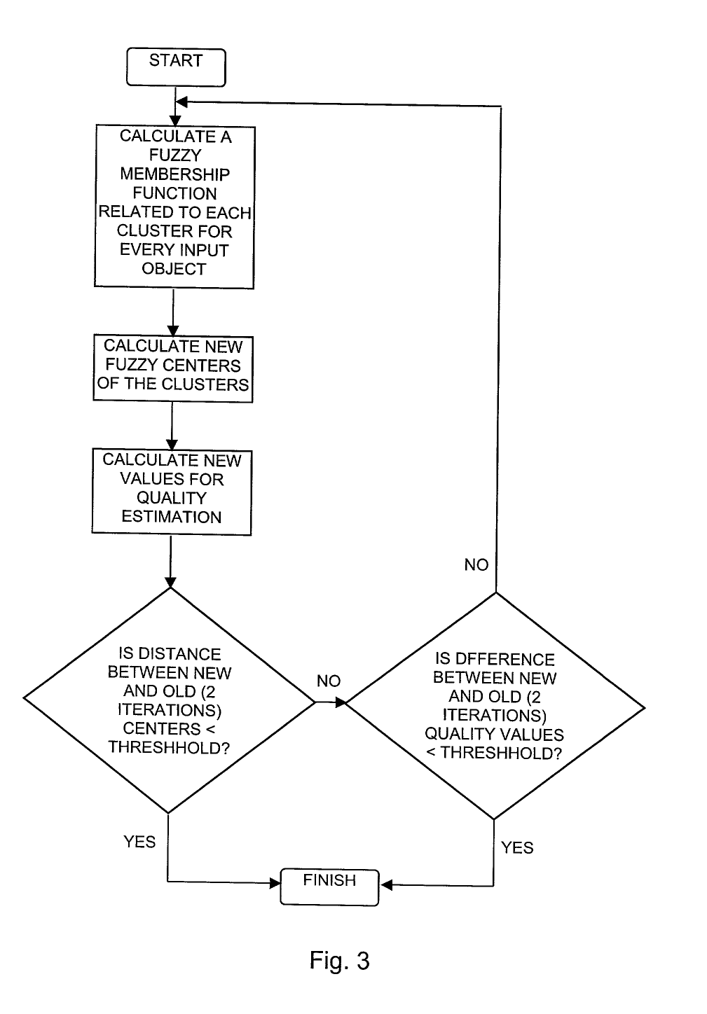

Each selected feature is evaluated using conventional processing techniques, such as image processing, for each object in the learning set, resulting in a feature value for each object-feature combination. Conventional cluster analysis techniques are then performed on the population of objects to identify clusters of objects with common features that will form the basis for object classes. Where the number of classes contained in the learning set is not known in advance, cluster analysis may be performed to automatically determine the number of separate clusters in the learning set, such as is described in greater detail hereinbelow with reference to FIG. 2. Where the number of classes contained in the learning set is predetermined, fuzzy cluster analysis techniques may be used, such as is described in greater detail hereinbelow with reference to FIG. 3.

Once the clusters have been identified, an average feature value for each feature in each cluster is calculated. The bottom-level node statement corresponding to each cluster feature is then expressed in a positive, negative, or intermediate form corresponding to the average feature value. For example, given an average feature value f and the statement from the corresponding bottom-level node of the ontology tree, a new statement is generated according to the following logic:

f>0.66: Positive sentence

f<0.33: Negative sentence

0.33≦f≦0.66: Intermediate form of the sentence

In this example, it is assumed that the feature values belong to the numeric interval [0; 1], and features are treated as fuzzy logic predicates.

Where the statement is positive in the bottom-level node, a negative form may be constructed by context word replacement. For example, “causes” may be replaced with “does not cause,” “covers” with “does not cover,” “has” with “does not have,” etc. Similarly, intermediate forms may be constructed by incorporating expressions such as “more or less” before the corresponding verbs. Such replacements may be predefined for any or all statements in the ontology tree, or may be applied using any applicable natural language processing techniques.

Each statement generated for the features in a cluster may be combined to form a sentence that describes the cluster. For example, “Defect has a green area” and “Extra pattern fragments exist” may be combined to form “Defect has a green area, and extra pattern fragments exist.”

It is appreciated that some or all of the steps of the method of FIG. 1 may be repeated using different selected features and/or with different clustering parameters as may be applied using known cluster analysis techniques in order to modify the character of the learning set. The results of the clustering may also be manually changed. Both options may be useful where the ADC system user disagrees with the number and/or character of the automatically formed clusters. For example, an object that is found in one cluster may be manually reassigned to a different cluster that the user deems to be more suitable.

Reference is now made to FIG. 2, which is a simplified flowchart illustration of a method of clustering objects where the number of clusters is not known a priori, operative in accordance with a preferred embodiment of the present invention. The method of FIG. 2 provides for automatic determination of the number of clusters relating to the feature space formed by features chosen from the ontology tree. In the method of FIG. 2 a matrix M[i, j] is constructed where i=1, 2, . . . ,N; j=1, 2, . . . , F, where N is the number of objects and F is the number of features. A triangular matrix of the Euclidean distances between input objects D[i, j] is then computed from input matrix M[i, j], where I=1, 2, . . . ,N; j=i+1, . . . , N, and where N is number of objects. A histogram H[m] of the distance matrix D[i, j] is then computed using a predetermined number of histogram intervals, such as 10. A distance threshold DistThreshold is then computed using the histogram minimum between the first two peaks, where DistThreshold=arg(min H[m]). A triangular incidence matrix K[i, j] is then computed using the distance matrix D[i, j] as follows:

if D[ij]>DistThreshold then K[ij]=0;

if D[ij]≦DistThreshold then K[ij]=1.

Using a matrix of incidences, cluster arrays are constructed and the number of clusters calculated according to the following rules:

objects i, j belong to the same cluster if K[i, j]=1;

objects i, j belong to the different clusters if K[i, j]=0.

Reference is now made to FIG. 3, which is a simplified flowchart illustration of a method of clustering objects where the number of clusters is known a priori, operative in accordance with a preferred embodiment of the present invention. For learning sets with a predefined number of clusters, conventional fuzzy cluster analysis techniques may be used. Such fuzzy cluster analysis techniques typically employ iterative algorithms where an initial clustering of the input objects is improved by subsequent iterations. A standard quality estimation of the clustering may be determined by calculating the variation of distances between the objects and the corresponding cluster center for every separate cluster. The sum of such values may then be used to characterize the clustering quality.

In the method of FIG. 3, during each iteration a fuzzy membership function related to each cluster is calculated for every input object using the distance between each cluster center and the current object. Using this membership function, new fuzzy centers of the clusters and new values for clustering quality estimation are calculated. The iterative process may conclude once, for two consecutive iterations, the distance between new and old centers of the clusters, or the difference between new and old values of quality estimation, is less then a predefined threshold. Transformation of fuzzy clustering to crisp (non-fuzzy) clustering may be made according to the winner strategy, where each object receives the label of a cluster for which its membership function is maximal.

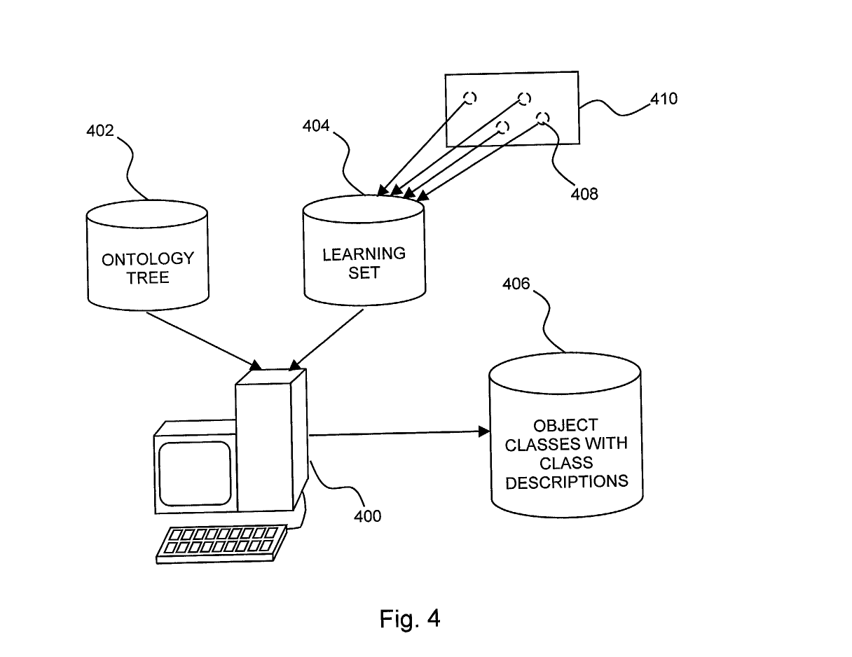

Reference is now made to FIG. 4, which is a simplified conceptual illustration of an object class definition system, constructed and operative in accordance with a preferred embodiment of the present invention. In the system of FIG. 4 a user at a computer 400 selects features from an ontology tree 402 for application to objects in a learning set 404, as described hereinabove with reference FIGS. 1-3. Learning set 404 typically comprises a group of objects such as defect images 408 taken of a microchip 410. Computer 400 then applies the methods of FIGS. 1-3 to produce object classes with class descriptions 406.

It is appreciated that one or more of the steps of any of the methods described herein may be omitted or carried out in a different order than that shown, without departing from the true spirit and scope of the invention.

While the methods and apparatus disclosed herein may or may not have been described with reference to specific hardware or software, it is appreciated that the methods and apparatus described herein may be readily implemented in hardware or software using conventional techniques.

While the present invention has been described with reference to one or more specific embodiments, the description is intended to be illustrative of the invention as a whole and is not to be construed as limiting the invention to the embodiments shown. It is appreciated that various modifications may occur to those skilled in the art that, while not specifically shown herein, are nevertheless within the true spirit and scope of the invention.

What is claimed is:

1. A method for object class definition for a plurality of objects, the method comprising:
evaluating each of a plurality of features for each of said objects, thereby resulting in a feature value for each object-feature combination;
performing cluster analysis on said objects to identify clusters of said objects having common features;
calculating an average feature value for each feature in each of said clusters; and
expressing a predefined statement associated with any of said cluster features in any of a positive, negative, and intermediate form corresponding to said cluster feature's average feature value.

2. A method according to claim 1 and further comprising providing an ontology tree comprising a plurality of predetermined features.

3. A method according to claim 2 and further comprising selecting a plurality of said features from said ontology tree.

4. A method according to claim 3 wherein said selecting step comprises selecting a plurality of bottom-level nodes of said ontology tree.

5. A method according to claim 2 and further comprising accepting a selection by a user of a plurality of said features from said ontology tree.

6. A method according to claim 5 wherein said accepting step comprises accepting said selection of a plurality of bottom-level nodes of said ontology tree.

7. A method according to claim 2 wherein said providing step comprises providing said ontology tree with a plurality of top-level feature groups, each of said top-level feature groups comprising at least one bottom-level node.

8. A method according to claim 7 wherein said providing step comprises providing said plurality of top-level feature groups wherein each of said plurality of top-level feature groups defines an orthogonal category of said features.

9. A method according to claim 3 wherein said providing step comprises providing a plurality of top-level feature groups, each of said top-level feature groups comprising at least one bottom-level node, each of said plurality of top-level feature groups defining an orthogonal category of said features, and wherein said selecting step comprises selecting no more than one bottom-level node from each orthogonal top-level feature group.

10. A method according to claim 5 wherein said providing step comprises providing a plurality of top-level feature groups, each of said top-level feature groups comprising at least one bottom-level node, each of said plurality of top-level feature groups defining an orthogonal category of said features, and wherein said accepting step comprises accepting no more than one bottom-level node from each orthogonal top-level feature group.

11. A method according to claim 1 and further comprising associating any of said features with any of a property, a statement, and a predicate.

12. A method according to claim 1 and further comprising combining a plurality of said statements expressed for any of said clusters to form a sentence that describes said cluster.

13. A method according to claim 1 wherein said performing step comprises:
constructing a matrix of said objects and said features;
computing a triangular distance matrix of the Euclidean distances between said objects in said object-feature matrix;
computing a histogram of said distance matrix using a predetermined number of histogram intervals;
computing a distance threshold using the minimum of a first and a second peak of said histogram;
computing a triangular incidence matrix using said distance matrix wherein:
a first value is recorded in said incidence matrix for any object member of said distance matrix that exceeds said distance threshold;
a second value is recorded in said incidence matrix for any object member of said distance matrix that does not exceed said distance threshold; and
constructing a cluster array using a matrix of incidences wherein a number of clusters is calculated wherein:
any of said objects belongs to the same cluster if said second value is recorded for said object member; and
any of said objects belongs to the same cluster if said first value is recorded for said object member.

14. A method according to claim 1 wherein said performing step comprises:
for each of a plurality of iterations:
calculating a fuzzy membership function related to each cluster for each of said objects using the distance between each cluster center and a current object;
calculating a fuzzy center for each of said clusters and a clustering quality estimation value using said fuzzy membership function; and
concluding said iterations when either of the distance between said centers of the clusters of two nonconcurrent iterations and the difference between said clustering quality estimation values is less then a predefined threshold.

15. A system for object class definition for a plurality of objects, the system comprising:
means for evaluating each of a plurality of features for each of said objects, thereby resulting in a feature value for each object-feature combination;
means for performing cluster analysis on said objects to identify clusters of said objects having common features;
means for calculating an average feature value for each feature in each of said clusters; and
means for expressing a predefined statement associated with any of said cluster features in any of a positive, negative, and intermediate form corresponding to said cluster feature's average feature value.

16. A system according to claim 15 wherein said objects comprise a learning set.

17. A system according to claim 15 and further comprising an ontology tree comprising a plurality of predetermined features.

18. A system according to claim 17 and further comprising means for selecting a plurality of said features from said ontology tree.

19. A system according to claim 18 wherein said means for selecting is operative to select a plurality of bottom-level nodes of said ontology tree.

20. A system according to claim 17 and further comprising means for accepting a selection by a user of a plurality of said features from said ontology tree.

21. A system according to claim 20 wherein said means for accepting is operative to accept said selection of a plurality of bottom-level nodes of said ontology tree.

22. A system according to claim 17 wherein said ontology tree comprises a plurality of top-level feature groups, each of said top-level feature groups comprising at least one bottom-level node.

23. A system according to claim 22 wherein each of said plurality of top-level feature groups defines an orthogonal category of said features.

24. A system according to claim 15 wherein any of said features is associated with any of a property, a statement, and a predicate.

25. A system according to claim 24 wherein said property expresses a concept of interest in a verbal form.

26. A system according to claim 24 wherein said statement expresses said property as a positive verbal statement.

27. A system according to claim 24 wherein said predicate is a system-level name of a formal feature which is related to a specific algorithm for calculating a feature value for any of said objects.

28. A system according to claim 15 wherein a plurality of said statements expressed for any of said clusters are combinable to form a sentence that describes said cluster.

29. A system according to claim 15 and further comprising:
means for constructing a matrix of said objects and said features;
means for computing a triangular distance matrix of the Euclidean distances between said objects in said object-feature matrix;
means for computing a histogram of said distance matrix using a predetermined number of histogram intervals;
means for computing a distance threshold using the minimum of a first and a second peak of said histogram;
means for computing a triangular incidence matrix using said distance matrix wherein:
a first value is recorded in said incidence matrix for any object member of said distance matrix that exceeds said distance threshold;
a second value is recorded in said incidence matrix for any object member of said distance matrix that does not exceed said distance threshold; and
means for constructing a cluster array using a matrix of incidences wherein a number of clusters is calculated wherein:
any of said objects belongs to the same cluster if said second value is recorded for said object member; and
any of said objects belongs to the same cluster if said first value is recorded for said object member.

30. A system according to claim 15 and further comprising:
means for calculating a fuzzy membership function related to each cluster for each of said objects using the distance between each cluster center and a current object;
means for calculating a fuzzy center for each of said clusters and a clustering quality estimation value using said fuzzy membership function; and
means for determining, for at least two nonconcurrent applications said of said means for calculating a fuzzy center, when either of the distance between said centers of the clusters calculated and the difference between said clustering quality estimation values is less then a predefined threshold.

31. A system according to claim 15 wherein said objects are microchip defect images, and wherein said features describe microchip defect image attributes.
